(19) United States
(12) Patent Application Publication
(10) Pub. No.: US 2016/0102726 A1
(43) Pub. Date: Apr. 14, 2016

(54) MASS DAMPER

(71) Applicant: David Martin Ford, Plymouth, MI (US)

(72) Inventor: David Martin Ford, Plymouth, MI (US)

(73) Assignee: NBJX USA, INC., PLYMOUTH, MI (US)

(21) Appl. No.: 14/511,403

(22) Filed: Oct. 10, 2014

(51) Int. Cl. F16F 7/12

(52) U.S. Cl. CPC F16F 7/124

(57) ABSTRACT

A tuned vibration mass damper for isolating vibrations from the steering wheel or other vehicle component includes an elastically cantilever mounted lead mass and a unitary thermoplastic bracket member made from a super tough plastic material and including a first or coupling portion for coupling the tuned vibration damper to a structure of the vehicle, a second portion for coupling the unitary bracket member to the lead mass, and an intermediate bight portion. The second coupling portion includes a plurality of cylindrically shaped legs extending through holes in the lead mass and having their ends formed (in a heading operation) to couple the unitary bracket member to the lead mass and a pair of travel limiters extending beyond the mass for preventing the mass from contacting other structures once the mass damper is installed.

The present disclosure generally relates to vibration mass dampers or absorbers for use in a vehicle for isolating or absorbing vibrations of the vehicle's various components and systems. More particularly, the present disclosure generally relates to an improved tuned, vibration absorber for preventing and/or limiting vibrations of the vehicle from being transferred to and/or felt by an individual in the vehicle.

### BACKGROUND

Tuned, vibration dampers or absorbers are generally known for use in damping or absorbing vibrations of various components of the vehicle from being transferred to other structures and/or occupants. In one particular application, a tuned, cantilevered, vibration absorber may be coupled to the steering column to prevent vibrations from being transferred to someone holding the steering wheel of the vehicle. Many examples of the innovations in the frequency tuned vibration dampers or absorbers are also generally known in the art.

Frequency tuned vibration dampening or absorbing devices may include an elastically suspended mass or body having one or more natural frequencies which are aligned with the natural frequencies of various components of the vehicle to be activated and to absorb such forces and prevent them from being transferred to other components of the vehicle. Examples of vibration mass dampers or absorbers include the devices disclosed in U.S. Pat. Nos. 4,697,781; 4,712,446; 5,180,147; 8,328,237; 8,505,701; and US Patent Application Publication No.: 2013/015272. The known vibration mass absorbers generally may include a vibratory mass comprising any one of various metal materials, including but not limited to, lead, zinc alloy, cast iron, or cast steel. While these are known typical materials used for the vibratory mass, certain preferences have developed. In general, the higher the density of the vibratory mass for the same geometry the greater the vibration attenuation or absorption. In some applications, it is known to use a cast iron material having a higher porosity as well as a cast zinc alloy or cast steel having an optimized higher density for the vibratory mass of the tuned mass absorber. It is generally understood that the higher the density of the material, typically provides better performance because it attenuates or absorbs the offending vibration better while providing quieter performance. Since in many automotive applications the tuned vibration absorber must be located in a restricted, limited and uniquely shaped space, a typical challenge for a steering wheel damper, lead may be a preferable choice for the vibratory mass but it also has its drawbacks.

It is also long been known and accepted to make a cantilevered tuned vibration mass damper including a lead vibratory mass coupled to a metal bracket and using an elastomer material coated on the bracket for mounting the vibration mass to the bracket. The process for manufacturing the known mass vibration damper includes a step for coating the metal bracket with an elastomer material for mounting the lead mass. While improvements to the known vibration mass damper have been made to reduce the amount of elastomer and to economize the application of the elastomer to the ferrous metal, all of the known vibration mass dampers use an elastomer which is applied using chemical baths including materials having potential environmental and health risks. Despite these known drawbacks and concerns, the use of an elastomer material in a tuned, vibration mass damper or absorber continues and the suggested alternative designs have been complicated, expensive, duplicative and ineffective without eliminating the elastomer material.

### DRAWINGS

FIG. 1 is a schematic, perspective view of a tuned vibration absorber according to the present disclosure.

FIG. 2 is a schematic, perspective view of a vibratory mass of the tuned vibration absorber of FIG. 1.

FIG. 3 is an alternate, schematic, perspective view of the tuned vibration absorber of FIG. 1.

FIG. 4 is a schematic, plan view of the tuned vibration absorber of FIG. 1.

FIG. 5 is a partial section view of the tuned vibration absorber of FIG. 4 taken along the section line 5-5 therein.

FIG. 6 is a schematic, perspective view of a tuned vibration absorber according to an alternate embodiment of the present disclosure.

FIG. 7 is a schematic, top view of the tuned vibration absorber of FIG. 6.

FIG. 8 is a schematic, bottom view of the tuned vibration absorber of FIG. 6.

FIG. 9 shows schematic end views of the tuned vibration absorber of FIG. 6.

FIG. 10 is schematic, side view of the tuned vibration absorber of FIG. 6.

FIG. 11 is a schematic, perspective view of a tuned vibration absorber according to an alternate embodiment of the present disclosure.

FIG. 12 is a schematic, top view of the tuned vibration absorber of FIG. 11.

### DETAILED DESCRIPTION

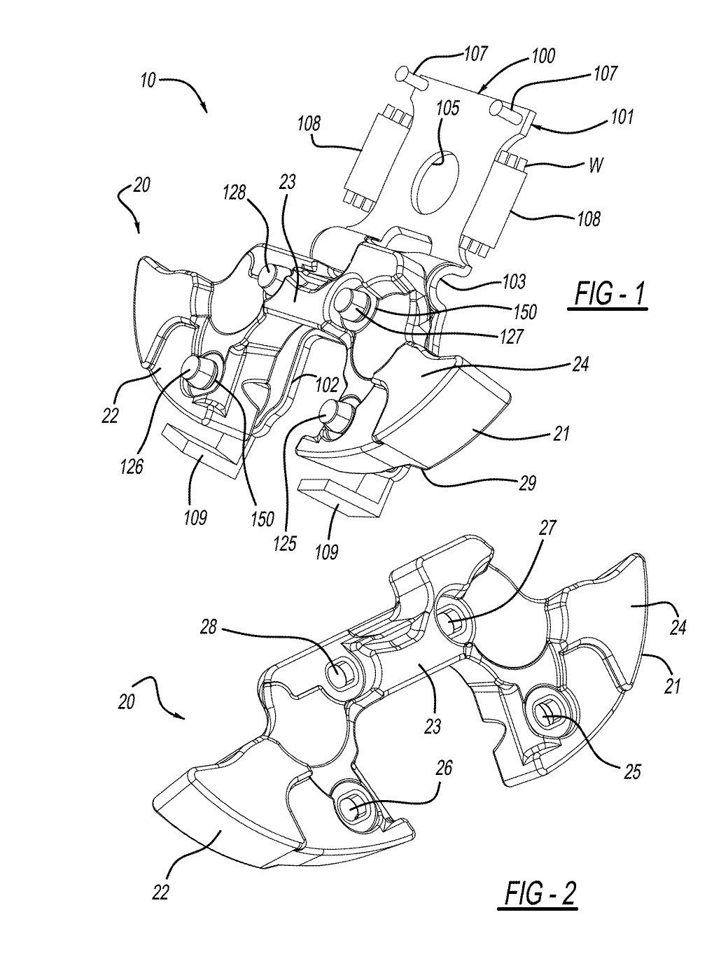

Referring in general to all of the Figures and in particular to the embodiment of FIGS. 1 through 5 there is disclosed an illustration of a tuned vibration damper or absorber 10 including a vibratory mass 20 and a bracket member 100 according to the exemplary embodiments of the present disclosure. It may be noted that all of the details of the vibratory mass 20 may not be shown in the illustrations of the Figures since those details are considered to be understood by a person having ordinary skill in the art of the present disclosure. In general, the mass 20 may include a first lobe or portion 21, a second lobe or portion 22 located distal from the first portion 21, and a third or intermediate portion 23 interconnecting the first portion 21 and the second portion 22.

As shown in FIGS. 1 and 2, the first side 24 of the vibratory mass 20 may vary among the first and second portions 21 and 22, respectively, and the third intermediary portion 23 so there may be a plurality of surface levels on the first side 24 of the mass 20. As best shown in FIG. 2, the mass 20 may include a plurality of holes 25, 26, 27, and 28 for coupling the mass 20 to the unitary bracket member 100. Each hole of the plurality of holes 25 through 28 of the mass 20 may preferably include a length extending from a first side 24 of the mass 20 to a second side 29 of the mass 20 and may each have a generally round cross-section but may alternatively have other shaped cross-sections. It should be noted that the second side 29 of the mass 20, like the first side 24, may have various portions at differing levels as best shown in FIG. 5. While the mass 20 of the exemplary embodiment of the present disclosure is shown as including four holes 25 through 28, it should be understood that it is possible to include fewer or greater number of holes in the plurality of holes in the mass 20. In particular, the number of holes in the mass 20 may preferably be selected to correspond to the number of posts or legs on the bracket member 100 for securing or coupling the mass 20 to the bracket member 100.

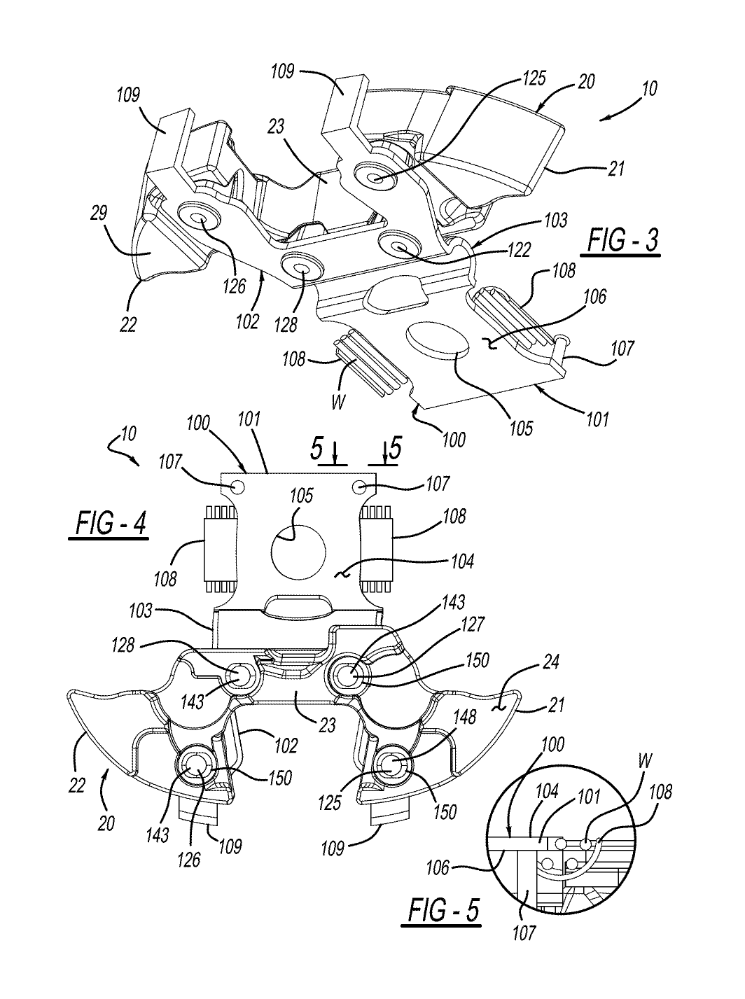

The bracket 100 may preferably include a first portion 101, a second portion 102, and a third or bight portion 103 located between the first portion 101 and the second portion 102. The unitary bracket member 100 may preferably be made in an additive manufacturing (e.g., or 3-D printed process) or injection molding process from a relatively high strength and strong thermoplastic material. The bracket 100 may include first and second extension members 107 coupled proximal an end and sides of the portion 101 of the bracket member 100 is shown in FIG. 1. The first and second extension members 107 may preferably be made unitary with the portion 101 of the bracket member 100 but may alternatively be separately coupled thereto. The first and second extension members 107 may include an enlarged or rounded and located distal the portion 101 of the bracket member 100 for protecting the components of the vibration mass damper 10 once installed. The bracket 100 may include laterally extending extension members 108 extending along the sides of the portion 101 of the bracket member 100 and generally having a arcuate or curved cross-sectional shape for receiving and maintaining the position of a plurality of wires W, when the mass damper 10 is installed as best shown in FIGS. 3 through 5.

In one exemplary embodiment of the present disclosure, the bracket member 100 may further include a first side 104 and a second or opposite side 106 as shown in FIG. 3. The first portion 101 of the unitary bracket member 100 may preferably include a centrally located hole or passage 105 for coupling or connecting the tuned vibration damper 10 to the vehicle in any of a variety of orientations including, in particular, a lateral orientation and a vertical orientation. The unitary bracket member 100 of the exemplary embodiment of the present disclosure may preferably include a plurality of extension members, legs or posts 125, 126, 127 and 128 corresponding to the holes 25, 26, 27 and 28 in the mass 20 for securing the mass 20 to the bracket 100. It should be understood that while the bracket member 100 of the exemplary embodiment of the present disclosure may include the four extension members 125-128 as the plurality of extension members it may be possible to include fewer or greater extension members for being received in the plurality of holes 25-28 in the mass 20 and/or using any other known or appropriate fastener, device or material for coupling the mass 20 to the bracket member 100.

Each extension member, post or leg 125-128 of the plurality of extension posts may preferably include a first portion located proximal the first side 104 of the bracket member 100 and extending substantially perpendicular from the first side 104. The first portion of each post 125-128 may have a particular cross-sectional shape (e.g., round or circular) and may extend distally from the first side 104 a predetermined length. The first portion of each post 125-128 may preferably extend a length correlated to and greater than the length of each recess in the side 29 of the mass 20 to support the mass 20 above the side 104 of the bracket 100. Each extension post of the plurality of extension posts 125-128 may also preferably include a unitary second portion extending distally from the end of the first portion and having a generally circular shaped cross-sectional area smaller than the generally circular shaped cross-sectional area of the first portion to define a ledge or shoulder for supporting the mass 20. The unitary second portion may be preferably chosen to have a length appropriate for passing through the respective passage or hole 25-28 in the mass 20 and for also including a heading or deforming operation for forming a third portion or end 143 of each extension post 125-128 for coupling, capturing, fastening the mass 20 to the bracket member 100 including, in one alternative embodiment, a shim, spacer or washer 150. Each extension post or leg 125-128 may preferably be sized and shaped to appropriately match the shaped, cross-sectional area of each hole 25-28 of the plurality holes of the vibratory mass 20 for coupling the mass 20 to the bracket member 100. The tuned vibration absorber 10 may preferably include the shim, spacer or washer 150 including a hole for being located on the second portion of each extension post 25-28 of the plurality of extension posts. Each shim 150 may preferably be made from a thermoplastic material similar to, or the same as, the thermoplastic material of the unitary bracket member 100. In one particular exemplary embodiment of the present disclosure, each shim 150 may preferably have a generally oblong shape wherein one pair of opposite sides have a generally flat or layer extent and the other opposite sides of each shim 150 may have a generally round or circular shape. The shim 150 may be locked to the extension posts of the plurality of extension posts 125-128 when an end portion 143 of the second portion 142 of each respective extension post is deformed in a heading operation. Once each unitary end portion 143 of each extension post is sufficiently deformed, the shim 150 and the mass 20 are connected, secured or coupled to the unitary bracket member 100.

The thermoplastic material used for the unitary bracket member 100 and/or spring leg 125-128 may be selected based on various operating criteria and factors for the installed environment including temperature, humidity, substance exposure and other criteria. Since the operation and performance of the tuned vibration absorber 10 will necessarily depend upon the details of the particular material (e.g., its elastic modulus) and the geometry of the post or leg (e.g., its working height and cross-section shape(s)), many different potential combinations of material and geometries exist—particularly given the significantly improved manufacturing flexibility provided by the design of the tuned vibration absorber 10 of the present embodiment. It is contemplated that the cross-section shape of the posts or legs 125-128 of the tuned vibration tuned vibration absorber 10 may be circular, square, triangular, rectangular, etc. depending upon the target frequency(ies) and direction(s) for the particular application for the tuned vibration absorber 10.

In one embodiment, the bracket member 100 of FIGS. 1 through 5 may preferably be made as an injection molded unitary bracket member 100 using a super tough, commercially available PA 66-8240 high strength plastic. The PA66 material may include glass reinforcement and exhibits a very useful and appropriate stiffness versus sag for a given geometry. The unitary bracket member 100 may alternatively be made from other plastic materials provided they may meet the testing and performance specifications and requirements for functioning as a tuned vibration damper 10 in a vehicle. The performance requirements for the tuned vibration absorber 10 may include, but are not necessarily limited to, having a maximum output acceleration about +/−0.1 g, and a tuned frequency in the range of between approximately 20 Hz to 50 Hz and having a peak at approximately 22 Hz at an average temperature and velocity.

The materials for bracket 100 may further include those having an appropriate combination of performance criteria for a given application including any combination of thermoplastics providing an appropriate combination of tensile strength, shear strength, percent elongation, glass transition temperature, hardness, modulus of elasticity, creep, impact resistance, and/or thermal conductivity. Many of these material properties may be a tuned parameter in the design of a tuned vibration absorber 10. One notable characteristic or performance factor for the material is the elastic modulus (E) because it directly affects the resonant or natural frequency of the assembly using the calculation (K/mass)^{1/2} (where K is the spring stiffness based upon the Young's modulus and the geometry). It is further recognized that other significant properties of the thermoplastic material are creep, strength and glass transition temperature.

The bracket 100 may more easily be adapted to include any of a plurality of designs and features including, as shown in FIGS. 1, 3 and 4, including the travel limiters 109 which may extend distally from the portion 102 of the bracket 100. Each travel limiter 109 may first extend a distance beyond the mass 20 (FIG. 4) in a plane substantially the same as the plane of portion 102 and the travel limiter 109 may then extend substantially perpendicular with respect to the portion 102 a distance greater than the side 24 of the mass 20. Once the mass 20 is installed, the travel limiters 109 may avoid and/or limit the buzz, squeak, rattle, and/or noise, including any “clunk” sound, from the mass 20 (a metal-based material) contacting the other components of vehicle (which may also include metal and/or other hard materials) where it may be installed. Other travel limiters may also be incorporated in any other appropriate location on the bracket 100. Significantly, the plastic material of the bracket 100 of the vibration absorber 10 of current embodiment does not need to be coated with an elastomer material for supporting the mass 20.

In one embodiment, the bracket 100 may be made integral using a plurality of components and may not be made unitary in its entirety. The plurality of posts or legs 125-128 may be made separately from the unitary base portions 101, 102 and 103. Alternatively, instead of the unitary bracket 100 described above, a bracket 100 may include unitary or integrated base portions 101, 102 and 103 made from a metal or alloy material and the posts or legs 125-128 may be made independently from the base portions from a thermoplastic (or other different) material and each post or leg may have one end coupled to the base portion 102 and an opposite end coupled to the vibratory mass 20. The ends of the posts 125-128 may be coupled to the mass 20 in a manner similar to that described above or in another unique manner. For example, the bracket 100 may be molded with a retention or clip feature so that the mass 20 may be snapped into place on the posts or legs 125-128 instead of using an extraneous fastener or formed coupling 143. In any of the various couplings of the base portion 102 to the vibratory mass 20, it may be possible to use the shim 150 and to select its material appropriately for the particular details of the coupling.

The tuned vibration absorber 10 of the exemplary embodiments of the present disclosure, in particular FIGS. 1 through 5, may be manufactured in a variety of steps. In one exemplary embodiment of the present disclosure, the tuned vibration damper 10 may be manufactured in a first step of performing an injection molding of the thermoplastic bracket member 100 to include the first portion 101, the second portion 102 and the intermediate third bight portion 103. Notably, the manufacturing of the thermoplastic bracket member 100 may, in one embodiment, exclude metal materials and/or any other material which may react with the material of the mass 20. In this embodiment, a metal washer or insert 115 may be located proximal the passage 105 in first portion 101 of the bracket member 101 for coupling the tuned vibration absorber 10 to a steering column or other structure of the vehicle.

In a further alternate embodiment, the bracket 100 of the tuned vibration absorber 10 may be produced using a metal portion and a plurality of thermoplastic supports (equivalent to the plurality of extension posts) coupled to the metal bracket 100 and the vibratory mass 20. In a separate manufacturing step, a vibratory mass may be produced in any known or appropriate process to include the plurality of passages or holes 25 through 28. In one embodiment, the step of producing the vibratory mass 20 may include a step of casting the mass 20 to be performed before, at the same time, or after the injection molding of the thermoplastic bracket 100.

Once the mass 20 is produced (i.e., cast) and the bracket member 100 is produced (i.e., molded), the next step of producing the tuned vibration damper 10 is to locate or couple the lead mass 20 to the thermoplastic unitary bracket member 100 by locating each extension post of the plurality of extension posts 125-128 of the unitary bracket member 100 in a respective hole of the plurality of holes 25 through 28 of the lead mass 20. Each end 143 of the extension post of the plurality of extension post 125-128 may then be deformed or headed in a heading operation to deform the thermoplastic material of the second portion 142 a sufficient amount to expand the thermoplastic material beyond the size of the holes 25 through 28 of the mass 20. In an alternate embodiment of the present disclosure, a shim 150 may be located on each end of each extension post of the plurality of extension posts 125-28 prior to the step of deforming or heading each extension post of the plurality of extension posts 125-128. In a further embodiment, the plurality of extension posts 125-128 may be separately produced from the bracket member 100 and both ends of the extension posts may be deformed to couple the mass 20 to the bracket member 100. In a further alternate embodiment, the bracket member 100 may be produced using a three dimensional printing process. Similarly, the plurality of extension posts 125-128 may be separately produced using a three dimensional printing process. In a further alternate embodiment of the present disclosure, the plurality of extension posts 125-128 may be three-dimensionally printed to be coupled with the mass 20 and the bracket member 100 such that no deforming of the ends of the plurality of extension posts 125-128 may be required.

The tuned vibration damper 10 may exclude any elastomeric material for mounting the lead mass 20 to the bracket member 100 since the unitary bracket member 100 is formed from a thermoplastic material which will not have any corrosive or galvanic action with the lead mass 20 as compared to the known bracket members which include a ferrous metal material. The vibration mass absorber 10 of the present embodiments provides a significantly lower cost, simplified, and better quality product than those of the known art due to the simplified design to eliminate certain parts including, in particular, the use of an elastomer on metal material combination and the related significant costs and environmental draw backs.

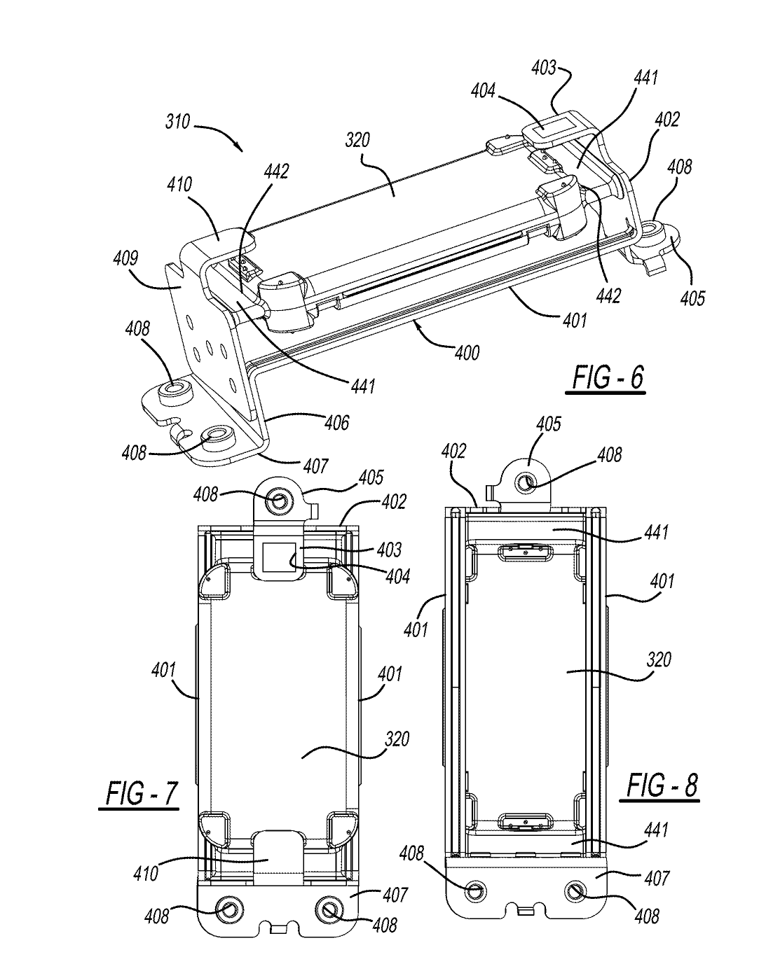

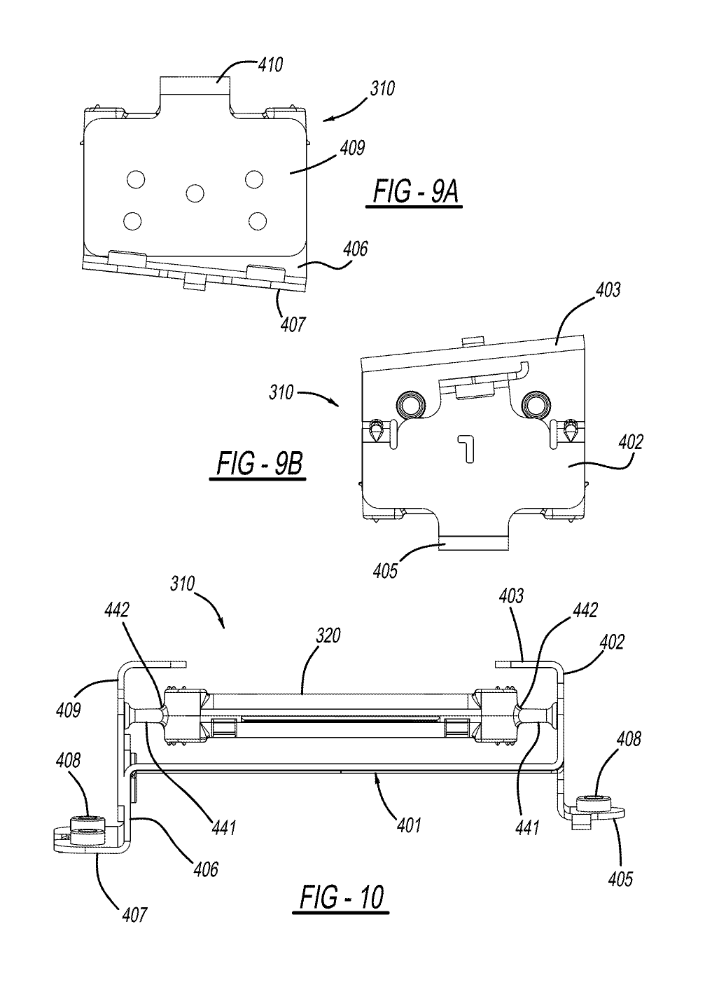

Referring now in particular to the embodiment of FIGS. 6 through 10 there is disclosed a graphic illustration of an embodiment of a tuned vibration damper or absorber 310 including a vibratory mass 320 and a bracket member 400 including longitudinal side members 401 extending substantially perpendicularly from an end of a first end portion 402. The first end portion 402 extends distally from its first end to a second end from which a second portion 403 extends perpendicularly with the second end of the first end portion 402 and aligned substantially parallel with the longitudinal side members 401. The second end portion 403 includes a passage or hole 404 therein. The first end of the first end portion 402 of the bracket member 400 may further include a first foot or extension member 405 extending distally in a direction substantially opposite and then substantially perpendicularly to the second portion 403 for coupling the tuned vibration damper 310 to a component or structure of the vehicle (not shown). The bracket member 400 may further include a fourth end portion 406 located opposite the first end portion 402 and coupled to the longitudinal side members 401 and extending substantially perpendicularly thereto. The bracket member 400 may further include a second foot or extension member portion 407 extending substantially perpendicularly from the fourth end portion 406 and substantially aligned parallel with the longitudinal side members 401. The second foot portion 407 may preferably be adapted for coupling the bracket member 400 of the tuned vibration absorber 310 to a component or structure of the vehicle (not shown). The bracket member 400 of the tuned vibration absorber 310 may preferably further include an end portion 409 coupled to the fourth end portion 406 and extending substantially aligned parallel there with and in a substantially opposite direction to the second foot portion 407. The end portion 409 may further preferably include an additional portion 410 extending in a direction substantially perpendicularly thereto and aligned with the longitudinal side members 401. It should be noted that the foot or extension members 405 and 407 of the bracket member 400 may include a hole or passage 408 for coupling the tuned vibration absorber 310 to a component of the vehicle (not shown).

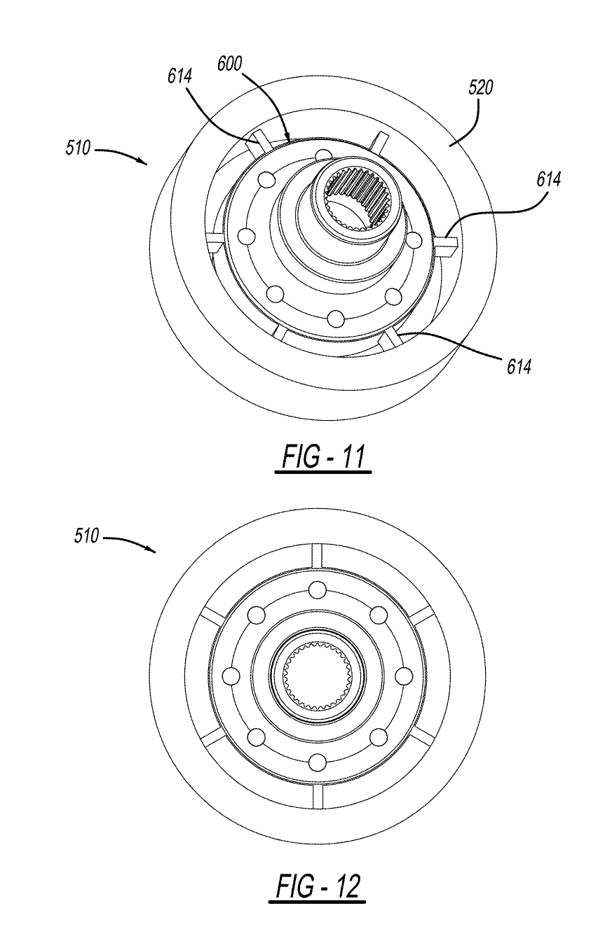

Tuned mass absorber 310 may further preferably include a first and second post or extension members 441 for coupling the mass 320 to the end portions 402 and 409 of the bracket member 400. The first and second extension members 441 may preferably be integrally coupled thereto and made of a plastic material similar to that of the tuned vibration absorber 10 of the embodiment of FIGS. 1 through 5. In one embodiment of the present disclosure, the tuned mass absorber 310 may preferably include a bracket member 400 consisting of a plastic material. In the present embodiment, the first and second extension members 441 may each preferably be an integral and unitary portion of the bracket member 400 where in the ends 442 of each of the first and second extension members 441 may be coupled to the vibratory mass 320 using a retention or clip feature fixedly coupling the plastic extension member 441 to the cast metal vibratory mass 320. Further, it is contemplated that the disclosures and teachings of the present embodiments of the subject disclosure may be applied to a rotational tuned vibration absorber 510 as best shown in FIGS. 11 and 12 wherein a vibratory mass 520 is coupled to a bracket member 600 by a plurality of extension members 641 extending radially between the bracket member 600 and the vibratory mass 520.

The description and figures are intended to be illustrative and not restrictive. Many alternate embodiments and many applications besides the exemplary embodiments provided will become apparent to those of ordinary skill in the relevant art upon understanding the present disclosure. The scope of the claimed invention should not be determined with limiting reference to the description and figures but should instead be determined with reference to the appended claims along with the full scope of equivalents to which such claims are entitled, Any reference or disclosure of an article or publication, including patents and patent applications, is intended to be an incorporation by reference herein for all purposes. Any omission in the claims of any aspect of subject matter disclosed in the description and figures is not intended to be a disclaimer of such subject matter.

Any numerical values recited herein or in the figures are intended to include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner, Unless expressly stated, all ranges are intended to include both endpoints and all numbers between the endpoints. The use of “generally, “about” or “approximately”, or similar words, in connection with a range applies to both ends of the range. Thus, “about 20 to 30” is intended to cover “about 20 to about 30”, inclusive of at least the specified endpoints.

The disclosure of “a” or “one” to describe an element, ingredient, component or step is not intended to foreclose additional elements, ingredients, components or steps. Plural elements, ingredients, components or steps may be provided by a single integrated element, ingredient, component or step. Alternatively, a single integrated element, ingredient, component or step may include separate plural elements, ingredients, components or steps.

We claim:

1. A tuned vibration damper for use in isolating a vibration in the vehicle suspension from the steering wheel of the vehicle, the tuned damper comprising:
a unitary bracket member consisting of a thermoplastic material and comprising a first coupling portion for coupling the tuned vibration damper to the vehicle, a second portion including a plurality of extension posts extending from a first side of the unitary bracket member and a third portion located between the first portion and the second portion; and
a mass including a plurality of holes wherein each hole of the plurality of holes receives an extension post of the plurality of extension posts for coupling the mass to the unitary bracket member.

2. The tuned vibration damper of claim 1 wherein each extension post of the plurality of extension posts includes a head portion having a length greater than a length of a cross-section of the hole in the mass and the head portion prevents the extension member from being removed from the hole in the mass.

3. The tuned vibration damper of claim 2 wherein the head portion of the extension member is formed unitary with the extension member after the extension member is located in the hole in the mass.

4. The tuned vibration damper of claim 2 wherein the thermoplastic material of the unitary bracket member is selected from the group consisting of nylon, and glass reinforced nylon for providing a unitary bracket member.

5. The tuned vibration damper of claim 2 wherein each extension post of the plurality of extension posts has a first portion having a first length located proximal the first side of the second portion of the tuned vibration damper and having a generally round cross section.

6. The tuned vibration damper of claim 5 wherein each hole of the plurality of holes of the mass has a generally round cross section sized to receive the first portion of the respective extension post of the second portion of the unitary bracket member.

7. The tuned vibration damper of claim 5 wherein each hole of the plurality of holes of the mass has a length generally matching the first length of the first portion of the extension post of the plurality of extension posts of the second portion of the tuned vibration damper.

8. A tuned vibration damper for use in isolating vibrations of a vehicle from a steering wheel of the vehicle, the tuned vibration damper comprising:
a unitary bracket member including a first portion for coupling the tuned vibration damper to the vehicle, a second portion having a first side and a second side, the second portion including a plurality of extension posts extending substantially perpendicularly from the first side of the second portion and a third bight-shaped portion located between the first portion and the second portion and wherein the unitary bracket member comprises a thermoplastic material and excludes all metal material;
a lead mass including a plurality of holes wherein each hole of the plurality of holes directly receives and contacts an extension post of the plurality of extension posts of the unitary bracket member for directly coupling the lead mass to the unitary bracket member and excludes any elastomeric material or coating to prevent the unitary bracket material from contacting the lead mass.

9. The tuned vibration damper of claim 8 wherein each extension post of the plurality of extension posts includes a head portion having a length greater than a length of a cross-section length of the hole in the mass and the head portion prevents the extension member from being removed from the hole in the mass.

10. The tuned vibration damper of claim 9 wherein the head portion of the extension member is formed unitary with the extension member after the extension member is located in the hole in the mass.

11. The tuned vibration damper of claim 9 wherein the thermoplastic material of the unitary bracket member is selected from the group consisting of nylon and glass-reinforced nylon providing a unitary bracket member.

12. The tuned vibration damper of claim 9 wherein each extension post of the plurality of extension posts has a first portion having a first length located proximal the first side of the second portion of the tuned vibration damper and having a generally round cross section.

13. The tuned vibration damper of claim 12 wherein each hole of the plurality of holes of the mass has a generally round cross section sized to receive the first portion of the respective extension post of the second portion of the unitary bracket member.

14. The tuned vibration damper of claim 12 wherein each hole of the plurality of holes of the mass has a length generally matching the first length of the first portion of the extension post of the plurality of extension posts of the second portion of the tuned vibration damper.

15. A method of manufacturing a tuned vibration damper comprising the steps of:
injection molding a thermoplastic unitary bracket member having a first portion for coupling the tuned vibration damper to the vehicle, a second portion having a first side and a second side, the second portion including a plurality of extension posts extending substantially perpendicularly from the first side of the second portion and a third bight-shaped portion located between the first portion and the second portion and wherein the unitary bracket member excludes metal;
casting a mass including a plurality of holes wherein each hole of the plurality of holes is aligned with an extension post of the plurality of extension posts;
coupling the mass to the thermoplastic unitary bracket member by locating each extension post in a respective hole in the mass; and
deforming each end of each extension post to lock the mass to the second portion of the thermoplastic unitary bracket member to prevent the unitary bracket material from contacting the mass.

16. The method of manufacturing a tuned vibration damper of claim 15 further comprising the steps of producing a plurality of washers each including a hole; and installing a washer of the plurality of washers on an end of each extension post of the plurality of extension posts after the step of coupling the mass to the thermoplastic unitary bracket member and before the step of deforming each end of each extension post.
